(19) United States
(12) Patent Application Publication
(10) Pub. No.: US 2017/0057573 A1
(43) Pub. Date: Mar. 2, 2017

(54) SNOWMOBILE SUSPENSION SYSTEM

(71) Applicant: Randy J. Gentry, Moscow, ID (US)

(72) Inventor: Randy J. Gentry, Moscow, ID (US)

(21) Appl. No.: 14/835,559

(22) Filed: Aug. 25, 2015

(51) Int. Cl. B62D 55/108; B62D 55/112; B62M 27/02

(52) U.S. Cl. CPC B62D 55/108; B62M 27/02; B62D 55/112; B62M 2027/026; B62M 2027/027

(57) ABSTRACT

A suspension system includes a swing arm having an end engaging a framework of a vehicle, an end engaging skid rails for a track. A front link has an end engaging the framework and a second end. The first end engages. A middle link has a end joined to the second end and a front portion of the swing arm, and a shock end. A shock has a end joined to the shock end, and a rail end engaging the skid rails. The front link, middle link and shock enable a rising rate system. A rear arm has an end engaging the framework, an end engaging a rear portion of the skid rails, and a length approximately a length of the swing arm. The rear arm is positioned approximately parallel to the swing arm during a travel range of the suspension system for controlling an orientation of the skid rails.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to vehicle suspensions. More particularly, the invention relates to a track type rear suspension comprising a single shock.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Most snowmobile rear suspensions use two shocks, one in the front of the suspension system and one in the rear of the system. It is believed that this may cause the suspension to be difficult to tune for different conditions or for different riders. Moreover, this may create additional complexity in the tuning and maintenance of the suspension. It is also believed that most snowmobiles employ a negative rate suspension, in which the suspension is typically stiff initially and then becomes softer near the end of the travel of the suspension. One may expect that this initial stiffness may result in the negative rate suspension not absorbing smaller bumps, which may lead to a rough and/or uncomfortable ride. Additionally, most snowmobiles comprise solid skids, the areas of the track system that typically make contact with the ground. Due to their size and shape, it is believed that these skids often cannot go down into holes in the ground or pitch to the side on hills, which may reduce traction and control on non-flat surfaces such as, but not limited to, bumpy trails or slopes.

By way of educational background, an aspect of the prior art generally useful to be aware of is that there are currently some suspension systems meant to achieve a rising rate suspension in which the stiffness increases with the travel of the suspension, rather than negative rate suspensions. One such system comprises a rising rate shock on the outside of the skid. It uses a single shock inside of the skid and track that that is negative rate and controls the front of the travel. Then there is a second shock outside of the skid and track that is attached to a linkage and mount behind the seat of the rider. This second shock is rising rate and controls the rear of the skid. Another system comprises two shocks on the inside of the skid with one shock having a rising rate. It is believed that such approaches may be complicated and/or difficult to tune for specific conditions or riders. Furthermore, such approaches may not handle snow buildup on the many components in the skid.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1G illustrate an exemplary suspension system typically employed within a track, in accordance with an embodiment of the present invention. FIG. 1A is a diagrammatic side view of the suspension. FIG. 1B is a diagrammatic side view of the suspension illustrating some of the inner elements. FIG. 1C is a side perspective view. FIG. 1D is a diagrammatic side view of the suspension with the track removed. FIG. 1E is a diagrammatic side view of the suspension in a compressed position. FIG. 1F is a diagrammatic side view of the suspension in a compressed position illustrating some of the inner elements, and FIG. 1G is a side perspective view of the suspension in a compressed position.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially”. (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to avoid a strict numerical boundary to the specified parameter,” see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, are generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

### TERMINOLOGY

The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may provide a snowmobile track type rear suspension comprising a single shock that may utilize a rising rate linkage ratio to control the suspension travel and a skid that can pivot in all directions. Some embodiments may deliver improved handling and rider comfort by absorbing small and large bumps and jumps smoothly with a simple to adjust system. Additionally, some embodiments may comprise a skid that is designed to pitch in all directions to the ground in order to maintain traction and improve control. Lastly, the suspension in many embodiments may incorporate a relatively simple system to allow for ease of adjustability and improved reliability.

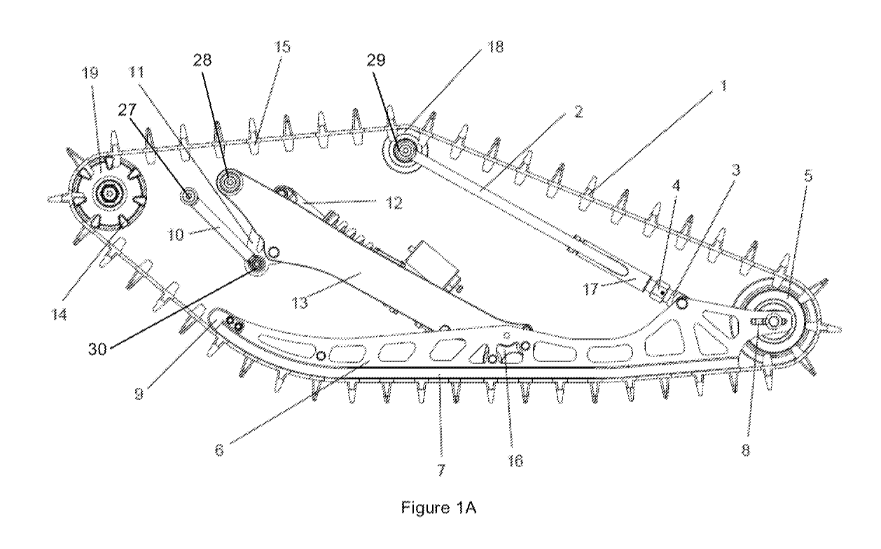

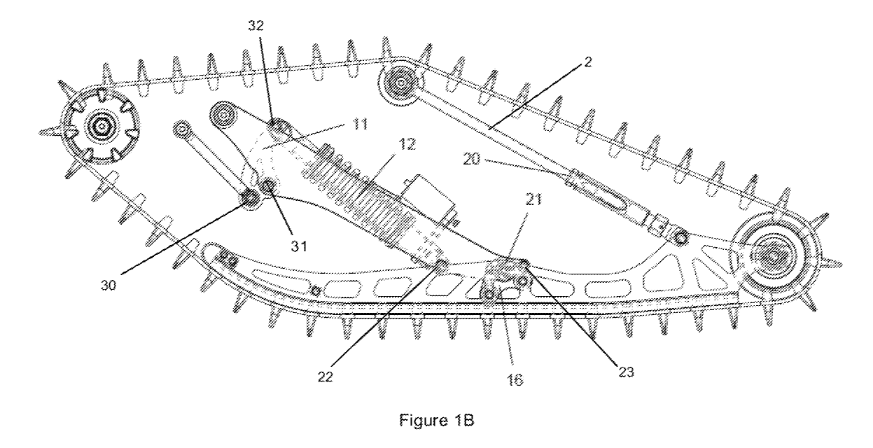

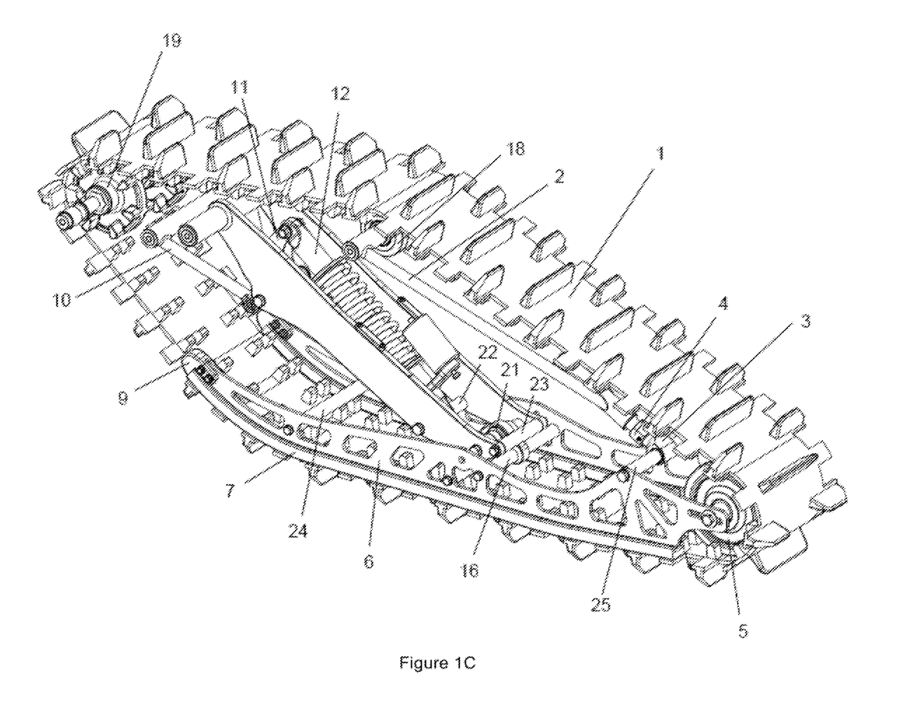

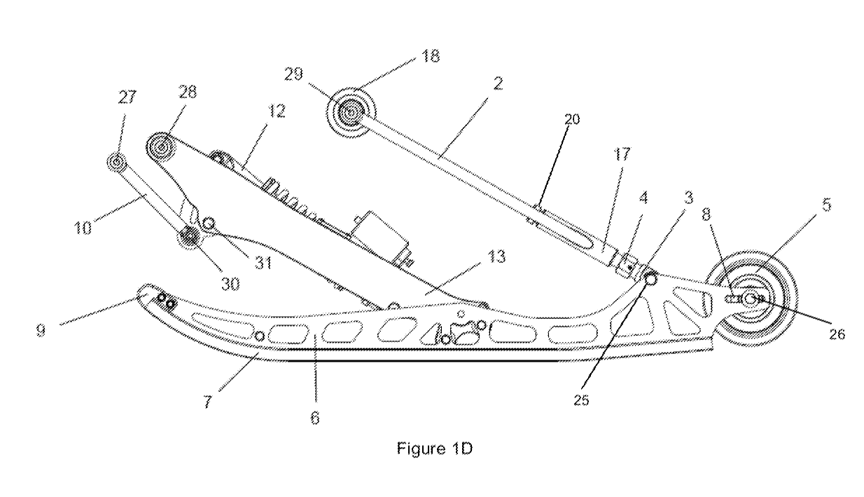

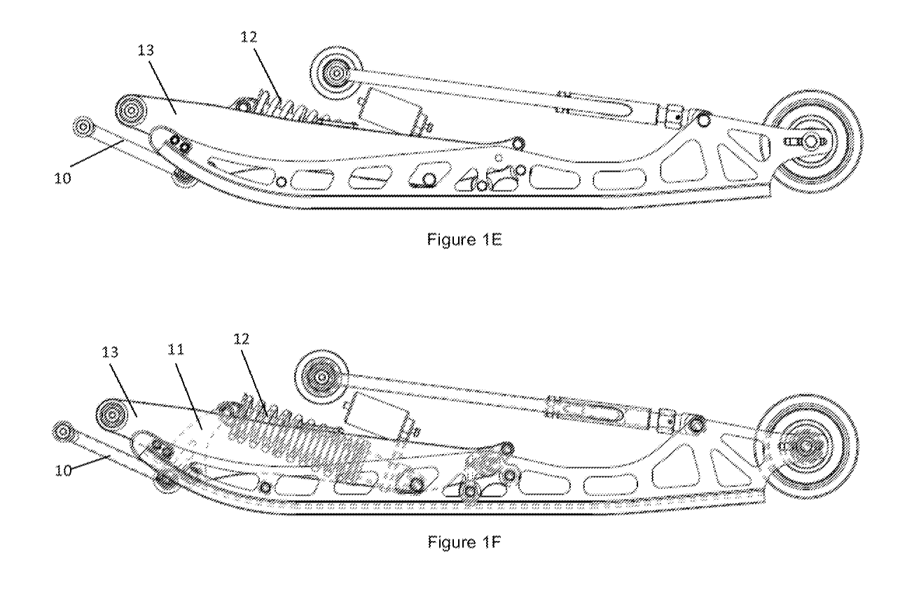

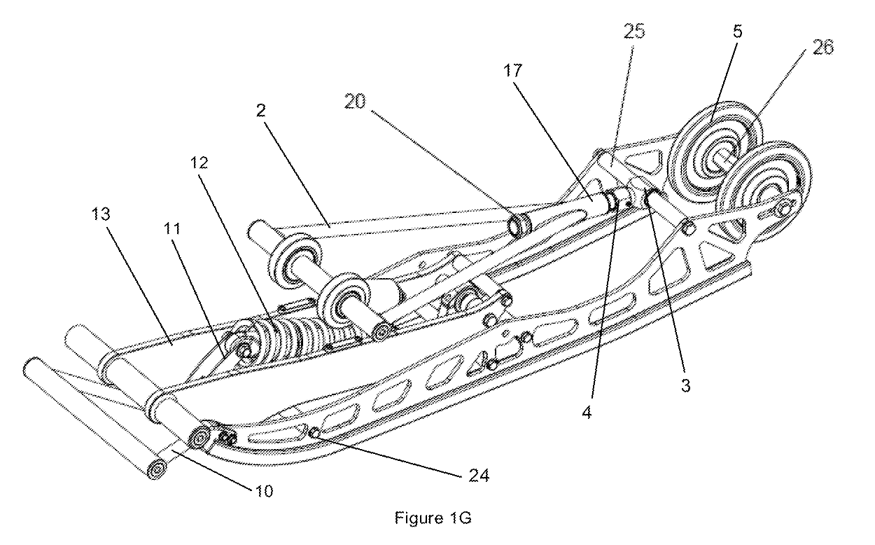

FIGS. 1A through 1G illustrate an exemplary suspension system typically employed within a track 1, in accordance with an embodiment of the present invention. FIG. 1A is a diagrammatic side view of the suspension. FIG. 1B is a diagrammatic side view of the suspension illustrating some of the inner elements. FIG. 1C is a side perspective view. FIG. 1D is a diagrammatic side view of the suspension with track 1 removed. FIG. 1E is a diagrammatic side view of the suspension in a compressed position. FIG. 1F is a diagrammatic side view of the suspension in a compressed position illustrating some of the inner elements, and FIG. 1G is a side perspective view of the suspension in a compressed position. In the present embodiment, the suspension system is fully contained inside track 1, which may be a continuous rubber belt, a track of metal linkages, chain, etc. Track 1 may be driven by a driveshaft 19 near the front of track 1 which is connected to the transmission of a vehicle such as, but not limited to, a snowmobile. Track 1 may be driven off of lugs 15 on track 1 and cog wheels 14 on driveshaft 19. Those skilled in the art will readily recognize, in light of and in accordance with the teachings of the present invention, that a multiplicity of suitable means may be used to drive the tracks of some alternate embodiments depending on factors such as, but not limited to, the type of vehicle, the type of transmission, the type of track, etc. For example, without limitation, in some alternate embodiments, the track may comprise a belt or chain, such as, but not limited to, a V belt, a roller chain, a ribbed belt, or a notched belt, that engages with the driveshaft to drive the track. In other alternate embodiments the track may engage with the drive shaft using friction plates or a clutch device.

In the present embodiment, a swing arm 13 may be bolted to the tunnel or frame of a vehicle at a top pivot point 28. In a non-limiting example, the tunnel is the framework of a snowmobile that is used to mount the snowmobile suspension to the vehicle. It usually runs the full length of the snowmobile from the driveshaft to the rear idler of the skid to keep snow off of the rider. Swing arm 13 may employ a bushing and shaft setup at pivot point 28 to typically enable swing arm to pivot at point 28. Swing arm 13 may also be connected to a pivot point 21 near the bottom. It is contemplated that various different types of attachment means may be used at pivot points 21 and 28 including, without limitation, a ball joint pivot as shown by way of example as pivot point 21, bushing and shaft connections, hinged connectors, bearing joints, etc. Some of these attachment means, for example, without limitation, a bushing and shaft pivot, may allow only forward and backward pivoting while others, such as, but not limited to, a ball joint pivot, may allow the lower portion of the suspension to pitch from side to side as well as pivot forward and backward. Depending on the application one solution may be more suitable than the other. In some embodiments, the type of connection device may depend on aspects such as, without limitation, required durability and the weight requirements as well as the desired type of pivot. Lower pivot point 21 of swing arm 13 may be mounted to rails 6 using a pivot frame 16. Rails 6 may help guide track 1 around the suspension system and may comprise plastic slides 7 attached to the full length or a portion of the bottom surfaces that may enable track 1 to slide easily over rails 6. Other embodiments may comprise alternate means for enabling the track to slide over the rails such as, but not limited to, bearings or lubrication.

Referring to FIGS. 1B and 1C, in the present embodiment, the suspension system comprises a single shock 12 near the front of the suspension and centrally located between rails 6. Shock 12 is illustrated by way of example as a mechanical spring; however, a multiplicity of suitable types of shocks may be used in some alternate embodiments including, without limitation, air shocks, hydraulic shocks, cushions, etc. Shock 12 may be connected to the suspension by a linkage system that typically provides a rising rate suspension motion. The linkage system for controlling shock 12 may comprise a front link 10, which may be mounted to the vehicle frame or tunnel at a pivot point 27, and a middle link 11, which may attach to front link 10 at a pivot point 30. Pivot points 27 and 30 may comprise bushing/shaft pivot connectors or various different types of pivoting attachment means. In some embodiments, they may also be attached using, without limitation, plain bearings, ball bearings, and needle bearings. Middle link 11 may also be connected to shock 12 at pivot point 32 and connected to swing arm 13 at pivot point 31. In addition, shock 12 may be connected to rails 6 at a pivot point 22. Again, pivot points 22, 31 and 32 may comprise bushing/shaft pivot connectors or any other suitable pivoting attachment means. In some embodiments, they may also be attached using, without limitation, plain bearings, ball bearings, spherical bearings, and needle bearings. In the present embodiment, the specific geometry and mounting locations of front link 10, middle link 11, and shock 12 may typically create a rising rate suspension. This means that when the entire lower skid, which may include without limitation all of the components attached to rails 6, takes an impact and starts moving upward, the suspension typically uses less stroke of shock 12 at the beginning of the upward motion and slowly starts using more stroke as the suspension is compressed further until the suspension is fully compressed as illustrated by way of example in FIGS. 1E, 1F, and 1G. The shock stroke to actual skid travel ratio changes how the suspension reacts to different types of impacts. In the present embodiment, the further compressed the suspension is the more resistance is required to compress further. This rising rate system uses more shock stroke per inch of suspension travel as it compresses than the previous inch causing a rapid increase in shock resistance allowing the suspension to be soft on small bumps and impacts yet also allowing the suspension to take much larger impacts without completely bottoming out the suspension and hurting the rider. The rising rate suspension may be able to absorb small bumps easily and may also be able to handle larger impacts, for example without limitation jumps, while maintaining rider comfort.

In the present embodiment, the suspension comprises control measures to typically allow only partial freedom of all pivots and connections. Referring to FIGS. 1B and 1C, a pivot stop 23 near pivot point 21 typically prevents the lower portion of the suspension to pivot upward in the front when the suspension is fully unloaded. This helps to maintain the skid in a substantially flat position while the skid is in the air, for example without limitation when jumping or going over bumps at high speed. This may aid in preventing tips 9 of rails 6 from pressing into track 1 and causing damage. It is contemplated that some alternate embodiments may be configured without this pivot stop, with pivot stops in different locations, for example, without limitation, near the front side of the pivot connector, or with different types of stops such as, but not limited to, rubber stoppers. In some other alternate embodiments, the suspension may use a limiter strap in the front which is attached to the tunnel and only allows the front to pivot down a little way, this may control the front in one direction.

Referring to FIGS. 1C, 1D and 1G, in the present embodiment, a rear arm 2, which may be approximately the same length as swing arm 13 and mounted at a similar angle to swing arm 13, may help to maintain the suspension characteristics throughout the entire upward and downward travel of the suspension. In the present embodiment, the rear arm being about the same length as the front arm may cause the suspension to act like a parallelogram and as they move they may maintain the same parallel angle to each other as before. This may cause the lower skid rails to stay in contact to the ground and remain in the same orientation throughout the entire suspension travel range. If the arm was not there or a vastly different size the lower rails may change orientation with the ground as the suspension moved causing reduced traction. The top of rear arm 2 may be mounted to the frame or tunnel of the vehicle at a pivot point 29, which may comprise a bushing and shaft setup or other suitable means to allow the pivot point to pivot. In some embodiments they may also be attached using, without limitation, plain bearings, ball bearings, and needle bearings. Idler wheels 18 may be mounted to pivot point 29 to enable track 1 to bend over and move across the top of rear arm 2 smoothly. Idler wheels 18 may be mounted so that they can rotate around pivot point 29 to enable wheels 18 to move with track 1 or may be mounted in a fixed position to enable track 1 to slide over wheels 18. Some alternate embodiments may comprise various different means for aiding the track in sliding over the rear arm such as but not limited to, bearings, rails similar to rails 6, channels or guides, etc. In the present embodiment, Near the bottom of rear arm 2 a sliding shaft 3 may be pivotally mounted to a pivot point 25, for example without limitation with a bushing and shaft, and connected to a bushing and shaft setup 17 that may slide in and out of rear arm 2. Alternately, in some embodiments the rear arm may slide in and out of the bushing and shaft setup. In the present embodiment, this telescoping feature typically enables rear arm 2 to become longer or shorter within a range that may be adjusted by a slide adjuster 4 and a slide stop 20. As rear arm 2 extends, the front portion of rails 6 may be able to pitch upward and the rear portion of rails 6 may be able to pitch downward. As rear arm 2 contracts, the rear portion of rails 6 may be able to pitch upward while the front may pitch downward. In the present embodiment, the rear arm may contract if there was a force exerted only on the rear of the suspension or if there was a force on the entire suspension that was more concentrated in the rear. It may extend if the front of the suspension had a larger force on it that the rear of the suspension. This may enable a user to adjust the range of motion of rear arm 2 to control the weight transfer and trail characteristics of the suspension. In a non-limiting example, if the range of motion in the rear arm is increased it may allow the skid rails to pitch up and down more freely allowing it to have more traction in rough and uneven terrain as well as allow more weight transfer when under hard acceleration. However the more the rails are allowed to pitch freely it may get less traction in really deep snow and on very tight corners as the suspension may settle to a non-optimal alignment for these conditions. The optimal alignment for these conditions may be parallel as show in the figures. Rear arm 2 typically limits motion of the suspension in nearly all directions, which may enable the suspension to pivot and maintain proper pitch to the ground while also helping to prevent the skid from binding up or pivoting to extreme angles while traversing rough terrain. It is contemplated that in some embodiments the rear arm may have a fixed length with no adjustment features. Other embodiments may be configured without the rear arm and all related components. In some of these embodiments the rear arm may be replaced with a strap or cable located near the front tips of the rails tips and the point where the front link of the suspension linkage attaches to the vehicle frame. This strap or cable may help to prevent the rails from damaging the track as the suspension compresses. In yet other embodiments the rear arm and its components may be removed with no replacement. In the present embodiment, pivot point 21 of swing arm 13 may enable the lower suspension to pivot freely in multiple directions with respect to the ground in order to maintain contact with the ground. Pivot point 21 may comprise a ball joint so that the skid can pivot forward and back as well as side to side simultaneously. This typically allows for increased traction and may enhance the smooth ride characteristics of the suspension by allowing the suspension to track through bumps or tilt to match sloped terrain. It is contemplated that some embodiments may comprise a bushing rather than a ball joint to connect the swing arm to the rails. These embodiments may enable the lower suspension to pivot forward and backward yet not side to side.

Referring to FIGS. 1C and 1G, in the present embodiment, at the rear of the suspension system at least two idler wheels 5 may be mounted on a cross shaft 26 to typically enable track 1 to bend around the suspension and move freely. Idler wheels 5 may be are mounted on shaft 26 using spacers and radial ball bearings, and shaft 26 may be mounted to rails 6 by being inserted into a slot 8 in rails 6. The tension of track 1 may be adjusted by moving the position of shaft 26 in slot 8. Adjusting the position of shaft 26 may also enable a user to account for wear of suspension components. In some embodiments the cross shaft may be permanently attached to the rails. In some embodiments, idler wheels 5 may be mounted in a fixed position to enable track 1 to slide over wheels 5. Other embodiments may comprise alternate means for aiding the track in curving around and moving over the rear portion of the suspension such as, but not limited to, bearings, rails similar to rails 6, channels or guides, etc. In the present embodiment, a cross shaft 24 may be located near the front of the suspension to add rigidity to the suspension. In embodiments configured for longer tracks, additional cross shafts may be located along the rails as needed for rigidity. In other embodiments various different components may be added for rigidity including, without limitation, plastic or rubber spacers between the rails, truss systems, reinforcing plates, etc.

Those skilled in the art will readily recognize, in light of and in accordance with the teachings of the present invention, that the components of some embodiments can be made using various technologies including, without limitation, welded assemblies, cast components, machined components, injection molded components, handmade components, etc. Furthermore, these components may be made of many different materials such as, but not limited to, steel, aluminum, alloys, other metals, plastic, rubber, fiberglass, composites, etc. Moreover, the components may be connected using a variety of suitable means as needed including, without limitation, bolts, nuts, rivets, washers, glue, press fits, set screws, shaft collars, circlips, welding, pins, etc.

Referring to FIGS. 1E, 1F, and 1G, in the present embodiment, the linkage system, front link 10 and middle link 11, and swing arm 13 typically enables the suspension system to have a high ratio of the stroke travel of shock 12 compared to suspension travel which is believed to be a performance advantage. The substantially large amount of shock 12 travel may also enable the suspension, including without limitation, the linkage system, shock 12, and swing arm 13, to collapse into a nearly flat position and into a small area. It is contemplated that linkages of various different configurations may be used in some embodiments including without limitation, linkage systems that do not collapse into a flat position. In alternate embodiments, a rising rate linkage may be added to the top of the swingarm as opposed to the bottom. Some embodiments may be implemented without a linkage system to typically provide a non-rising rate suspension by mounting a shock directly to the tunnel or frame of the vehicles and the rails.

In typical use of the present embodiment, a user may adjust the suspension to suit different riders, different vehicles, and/or different conditions by changing one or more of the various controls in the system including, without limitation, the length of rear arm 2, the position of cross shaft 26 in slot 8, adjusting side adjuster 4 or slide stop 20, etc. These adjustments may be easily performed because of the relatively simple single shock design. In a non-limiting example. if the rear arm slide adjuster is move up limiting the amount of slide travel it may result in improved deep snow performance at the expense of trail performance by reducing the amount the front or rear of the skid can move without the other end. The shock may also be adjusted and depends on the type of shock absorber used. Typical shock absorber adjusters include, without limitation, spring preload, high and low speed compression damping, rebound damping, gas pressure, internal valves, etc. Shock absorber adjustment may vary greatly and typically are used to tune for different conditions and riders. Also, by providing a compact system in which many of the main components are mounted in the skid, the suspension according to the present embodiment typically enables weight to be transferred easily to adjust for varying terrain. Since there is only one pivot point connecting the main swing arm 13 to the rails 6 it acts as the rear wheel of a motorcycle using a similar swing arm suspension and allows the vehicle to climb in and out of holes like a tire would in dirt or other rough terrain. In addition, the rising rate linkage system may typically enable the suspension to perform suitably in a broad variety of terrains without adjustments and may allow for the suspension to compensate for improperly tuned shocks in some situations. For example, without limitation, the suspension system described by way of example in the foregoing may have the ability to be driven through deep snow and on icy or hard trails with a very similar and high level of shock absorbing performance. In many cases the amount of floatation provided by the suspension coupled with the dynamic pitching of the skid may enable the vehicle to perform like a smaller trail sled on the trails yet float and climb like a long track mountain sled in deep powdery snow.

Various embodiments may be used on virtually any snowmobile or other over snow device such as, but not limited to, ski slope groomers or arctic rovers. Some embodiments may be implemented to be used on devices or vehicles with wheels that can be removed and replaced by a track system such as but not limited to, motorcycles, cars, suvs, pickups, bicycles, all-terrain vehicles, etc. In some applications the system may be used to convert a non over snow device into an over snow device. For example, without limitation, in one embodiment the suspension system by be used to convert a motorcycle into a single ski snowmobile. In this embodiment the ability of the skid to pitch back and forth and from side to side may be particularly useful to maintain balance on the single ski. In a non-limiting example, for the track system to work on a snow bike the dirt bike may require an additional drive train modification and tunnel addition in order for the suspension to mount in place of the rear wheel and swing arm of the original dirt bike. It is contemplated that some embodiments may be configured for vehicles that may be driven in conditions other than ice and snow such as, but not limited to, soft and muddy terrain or sandy terrain. For example, without limitation, some embodiments may be configured for use on vehicles such as, but not limited to, rovers or space explorations vehicles. Virtually any device or vehicle that can benefit from running on a track system for floatation, traction, or any other reason, may employ a slightly modified embodiment of the present invention. In one non-limiting example, in a vehicle or device that is meant to drive on terrain without water and ice, the rails of the suspension system may comprise many idler wheels to help enable the track to run smoothly without large amounts of friction. Moreover, some alternate embodiments may be implemented for use on vehicles or devices not using a track system. For example, without limitation, a linkage system, swing arm, and shock according to one embodiment may be connected to the frame and axle of a vehicle that is driven on wheels. Other embodiments may be configured for use on other types of vehicles and devices such as, but not limited to, non-motorized sleds, bicycles, train cars, etc.

It is believed that the relative simplicity of the single shock design of the present embodiment may allowing for easier tuning capabilities, overall lighter weight, and reduced manufacturing costs. Also, the rising rate motion of the linkage system may provide a smooth ride in a variety of conditions, which may enable riders to be more comfortable and more controlled. The smooth ride may also allow those with back problems or who are older to ride longer and more comfortably. The pivoting motion of the swing arm skid mount typically enables the entire skid to pivot side to side and back and forth to help maintain contact with the ground and provide additional traction and control. Traditionally, snowmobile suspensions may be tuned quite differently in order to work properly for vehicles of varying torque and horsepower. Since the centrally located suspension arm of the present embodiment may allow for auto correcting, the suspension may be able to work well for a wide range of vehicles.

Those skilled in the art will readily recognize, in light of and in accordance with the teachings of the present invention, that some embodiments may comprise a multiplicity of suitable components in addition to or instead of the components described by way of example in the foregoing. For example, without limitation, some embodiments may employ a linkage system comprising more or fewer linkages. Other embodiments may comprise various different means for controlling the motion of the skid. Yet other embodiments may comprise rails of various different shapes and sizes.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a track type rear suspension system comprising a single shock according to the present invention will be apparent to those skilled in the art. Various aspects of the invention have been described above by way of illustration, and the specific embodiments disclosed are not intended to limit the invention to the particular forms disclosed. The particular implementation of the suspension system may vary depending upon the particular context or application. By way of example, and not limitation, the suspension systems described in the foregoing were principally directed to vehicle implementations; however, similar techniques may instead be applied to devices other than vehicles such as, but not limited to, robots, passenger seating on mass transit vehicles, or earthquake absorbers in buildings, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A suspension system comprising:
a swing arm comprising a front end, a rear end and a swing arm length, said front end being configured to pivotally engage a framework of a vehicle, said rear end being configured to pivotally engage skid rails for a track;
a front link comprising a first end and a second end, said first end being configured to pivotally engage the framework;
a middle link comprising a pivot end and a shock end, said pivot end pivotally joining to said second end and separately pivotally joining to said swing arm on a front portion of said swing arm;
a shock assembly comprising a link end and a rail end, said link end pivotally joining to said shock end, said rail end being configured to pivotally engage the skid rails, wherein said front link, said middle link and said shock assembly enable a rising rate system; and
a rear arm comprising a frame end, a rear rail end and a rear arm length, said frame end being configured to pivotally engage the framework, said rear rail end being configured to pivotally engage a rear portion of the skid rails, said rear arm length being approximately said swing arm length, said rear arm being positioned approximately parallel to said swing arm during a travel range of the suspension system for controlling an orientation of the skid rails.

2. The suspension system as recited in claim 1, further comprising an adjustment assembly for adjusting said rear arm length.

3. The suspension system as recited in claim 2, in which said adjustment assembly comprises a slide adjuster and a slide stop.

4. The suspension system as recited in claim 1, further comprising a pivot stop for substantially maintaining an orientation of the skid rails when the suspension system is unloaded.

5. The suspension system as recited in claim 1, further comprising at least one idler wheel joined to said frame end for engaging the track.

6. The suspension system as recited in claim 1, in which said swing arm is disposed centrally to the suspension system.

7. The suspension system as recited in claim 6, in which said swing arm further comprises a ball joint for engaging the skid rails.

8. The suspension system as recited in claim 1, in which said rear arm further comprises a sliding shaft for joining to the rear portion of the skid rails, said sliding shaft being configured for a sliding motion within said rear arm.

9. The suspension system as recited in claim 1, in which said shock assembly comprises a mechanical spring.

10. The suspension system as recited in claim 1, in which said shock assembly is centrally disposable between the skid rails.

11. The suspension system as recited in claim 1, in which said rear arm comprises a y-shape opening to said frame end.

12. The suspension system as recited in claim 11, in which said frame end further comprises a bushing and shaft for engaging the framework.

13. The suspension system as recited in claim 1, said front end further comprises a bushing and shaft for engaging the framework.

14. The suspension system as recited in claim 1, in which the vehicle is a snowmobile.

15. A suspension system comprising:
means for engaging a framework of a vehicle and for engaging skid rails for a track;
means for linking to the framework;
means for joining said linking means and said engaging means;
means for enabling a rising rate system; and
means for controlling an orientation of the skid rails.

16. The suspension system as recited in claim 15, further comprising means for adjusting said controlling means.

17. The suspension system as recited in claim 15, further comprising means for substantially maintaining an orientation of the skid rails when the suspension system is unloaded.

18. The suspension system as recited in claim 15, further comprising means for engaging the track at an end of said controlling means.

19. A suspension system comprising:
a track being configured for moving a snowmobile, said track being configured for engagement with a motor of the snowmobile;
at least two skid rail in engagement with said track wherein said skid rails positions said track for contacting a surface below the snowmobile;
at least two idler wheels being joined to said skid rails configured for a adjusting a tension on said track;
a swing arm comprising a front end, a rear end and a swing arm length, said front end being configured to pivotally engage a framework of the snowmobile, said rear end being configured to pivotally join to said skid rails;
a front link comprising a first end and a second end, said first end being configured to pivotally engage the framework;
a middle link comprising a pivot end and a shock end, said pivot end pivotally joining to said second end and separately pivotally joining to said swing arm on a front portion of said swing arm;
a pivot stop for substantially maintaining an orientation of said skid rails when the suspension system is unloaded;
a shock assembly comprising a link end and a rail end, said link end pivotally joining to said shock end, said rail end pivotally joining to said skid rails, wherein said front link, said middle link and said shock assembly enable a rising rate system;
a rear arm comprising a frame end, a rear rail end and a rear arm length, said frame end being configured to pivotally engage the framework, said rear rail end joining to a rear portion of said skid rails, said rear arm length being approximately said swing arm length, said rear arm being positioned approximately parallel to said swing arm during a travel range of the suspension system for controlling an orientation of said skid rails;
two idler wheels joined to said frame end for engaging said track; and
an adjustment assembly for adjusting said rear arm length.

20. The suspension system as recited in claim 19, in which said swing arm further comprises a ball joint for engaging said skid rails and is disposed centrally to the suspension system, said shock assembly comprises a mechanical spring and is centrally disposable between the skid rails, said rear arm further comprises a sliding shaft for joining to said rear portion of said skid rails, said sliding shaft being configured for a sliding motion within said rear arm, said rear arm further comprises a y-shape opening to said frame end and a bushing and shaft for engaging the framework, said adjustment assembly comprises a slide adjuster and a slide stop.
